(19) United States
(12) Patent Application Publication
(10) Pub. No.: US 2024/0237162 A1
(43) Pub. Date: Jul. 11, 2024

(54) ADJUSTABLE DOOR HOOK ASSEMBLY

(71) Applicant: WHIRLPOOL CORPORATION, BENTON HARBOR, MI (US)

(72) Inventors: Simone Polvara, Bareggio (IT); Fulvio Airaghi, Rho (MI) (IT)

(73) Assignee: WHIRLPOOL CORPORATION, BENTON HARBOR, MI (US)

(21) Appl. No.: 18/407,939

(22) Filed: Jan. 9, 2024

Related U.S. Application Data
(60) Provisional application No. 63/479,406, filed on Jan. 11, 2023.

(51) Int. Cl. H05B 6/64

(52) U.S. Cl. CPC H05B 6/6417; F24C 15/022

(57) ABSTRACT

A cooking appliance includes an outer housing defining a receiving opening and an interlock system disposed within the outer housing proximate to the interlock opening. The interlock system includes a rotating cam and an interlock switch. A door assembly is operably coupled to the outer housing. The door assembly includes an inner panel defining an access aperture and a base operably coupled to the inner panel. The base defines an upper opening. The door assembly also includes a door hook disposed in the upper opening of the base and an adjustment assembly operably coupled to the door hook. The adjustment assembly is configured to linearly translate the door hook relative to the inner panel to adjust a position of the door hook. The position of the door hook adjusts an engagement between the door hook and the interlock system.

### CROSS-REFERENCE TO RELATED APPLICATION

This application claims priority to and the benefit under 35 U.S.C. § 119(e) of U.S. Provisional Application No. 63/479,406, filed on Jan. 11, 2023, entitled “ADJUSTABLE DOOR HOOK ASSEMBLY,” the disclosure to which is hereby incorporated herein by reference in its entirety.

### BACKGROUND OF THE DISCLOSURE

The present disclosure generally relates to an adjustable door hook assembly, and more specifically, to an adjustable door hook assembly for a microwave.

### SUMMARY OF THE DISCLOSURE

According to one aspect of the present disclosure, a cooking appliance includes an outer housing defining a receiving aperture and an interlock system disposed within the outer housing proximate to the interlock system. The interlock system includes a rotating cam and an interlock switch. A door assembly is operably coupled to the outer housing. The door assembly includes an inner panel defining an access aperture and a base operably coupled to the inner panel. The base defines an upper opening. The door assembly also includes a door hook disposed in the upper opening of the base and an adjustment assembly operably coupled to the door hook. The adjustment assembly is configured to linearly translate the door hook relative to the inner panel to adjust a position of the door hook. The position of the door hook adjusts an engagement between the door hook and the interlock system.

According to an aspect of the present disclosure, a cooking appliance includes a housing, an interlock system disposed within the housing, a door assembly including an inner panel defining an access aperture, and a door hook assembly operably coupled to the door assembly. The door hook assembly includes a base defining an upper opening and a door hook positioned within the upper opening. The door hook includes an engagement element configured to extend into the housing to engage the interlock system when the door assembly is in a closed position. The door hook assembly also includes an adjustment assembly operably coupled to the door hook. The adjustment assembly is configured to drive linear translation of the door hook to adjust a position of the door hook relative to the base. The position of the door hook adjusts a relationship between the door hook and an interlock switch as the door assembly is moved from the closed position to an opened position.

According to an aspect of the present disclosure, a door hook assembly for a cooking appliance includes a base defining an opening and a door hook disposed within the opening. The door hook has an engagement portion and a coupling portion. The door hook defines a receiving aperture. The engagement portion includes an engagement element configured to engage an interlock system of a cooking appliance. The door hook assembly also includes an adjustment assembly operably coupled to the door hook and that is configured to drive a linear translation of the door hook and a door hook fastener selectively disposed within the receiving aperture. The door hook fastener is movable between an unfixed condition and a fixed condition. The door hook is linearly translatable relative to the base when the door hook fastener is in the unfixed condition. The door hook is fixed to the base when the door hook fastener is in the fixed condition.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a side perspective view of a cooking appliance with a door assembly in

a closed position and a button for opening the door assembly, according to the present disclosure;

FIG. 1B is a side perspective view of a cooking appliance with a door assembly in a closed position and a handle, according to the present disclosure;

FIG. 2 is a side perspective view of a door assembly for a cooking appliance with a door hook assembly, according to the present disclosure;

FIG. 3 is a partially exploded side perspective view of a door assembly for a cooking appliance with a door hook assembly, according to the present disclosure;

FIG. 4 is a top plan view of a door hook assembly on a door assembly and an interlock system in a cooking appliance with the door assembly in an opened position, according to the present disclosure;

FIG. 5 is a top plan view of the door hook assembly of FIG. 2 engaging the interlock system with the door assembly in a closed position, according to the present disclosure;

FIG. 6 is a partial side perspective view of a door assembly with a door hook assembly, according to the present disclosure;

FIG. 7 is a partial side perspective view of a door hook assembly with an adjustment assembly, according to the present disclosure;

FIG. 8 is a partial side perspective view of a door hook assembly with an adjustment assembly configured as an eccentric screw, according to the present disclosure;

FIG. 9 is an exploded partial side perspective view of a door hook assembly with an adjustment assembly configured as an eccentric screw, according to the present disclosure;

FIG. 10 is a partial side elevational view of a door hook assembly with an adjustment assembly configured as an eccentric screw, according to the present disclosure;

FIG. 11 is a side perspective view of an eccentric screw for an adjustment assembly for a door hook assembly, according to the present disclosure;

FIG. 12 is a partial side perspective view of a door assembly for a cooking appliance with a door hook assembly that has an adjustment assembly configured as a rack and pinion gear set, according to the present disclosure;

FIG. 13 is a partial side perspective view of a door assembly for a cooking appliance with a door hook assembly that has an adjustment assembly including an insert, according to the present disclosure;

FIG. 14 is a partial side elevational view of a door assembly for a cooking appliance with a door hook assembly that has an adjustment assembly configured as a biasing member and an insert, according to the present disclosure; and

FIG. 15 is a flow diagram of a method of manufacturing a cooking appliance with a door hook assembly, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a door hook assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

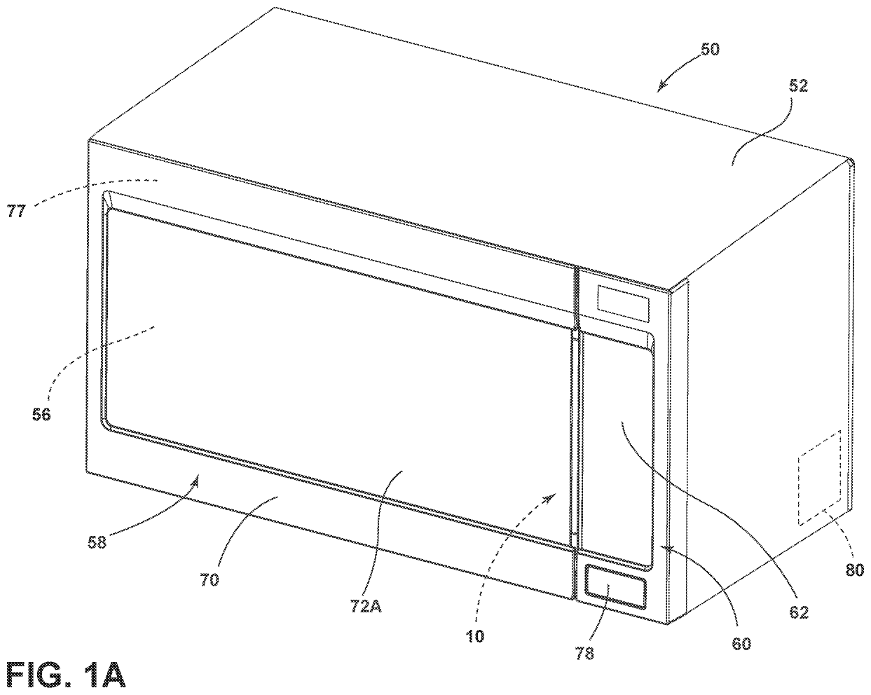

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

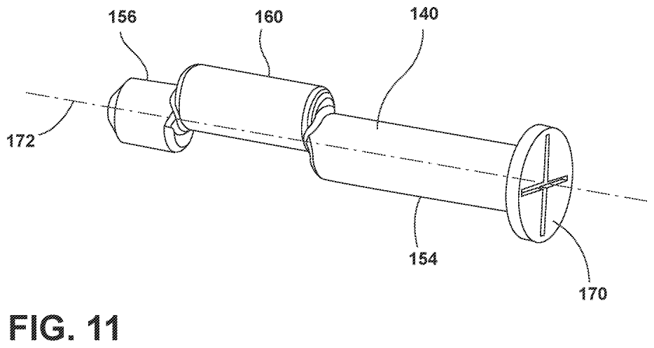

Referring to FIGS. 1A-15, reference numeral 10 generally designates a door hook assembly that includes a base 12 defining an upper opening 14. A door hook 16 is supported by the base 12 and extends through the upper opening 14. The door hook 16 includes an engagement portion 18, and the door hook 16 also defines a first receiving aperture 20. The engagement portion 18 includes an engagement element 22 extending from the engagement portion 18, and the engagement element 22 defines an aperture 24.

The door hook assembly 10 includes an adjustment assembly 26 operably coupled to the door hook 16. The adjustment assembly 26 is configured to drive or promote linear translation of the door hook 16. A door hook fastener 28 or fixing fastener 28 is selectively disposed within the first receiving aperture 20. The door hook fastener 28 is movable between an unfixed condition, where the door hook 16 is linearly translatable relative to the base 12, and a fixed condition, resulting in the door hook 16 being fixed to the base 12 or in a static condition where movement of the door hook 16 is reduced or prevented.

Referring still to FIG. 1A, the door hook assembly 10 is included in a cooking appliance 50, which may be an oven, a microwave oven, a convection oven, a steam oven, a conventional oven, or other cooking apparatus. In the illustrated example of FIG. 1A, the cooking appliance 50 is a microwave oven 50 that includes an outer housing 52, as well as an inner housing 54 that is positioned within the outer housing 52 and that defines a cooking cavity 56.

The microwave oven 50 includes a door assembly 58 that selectively closes and provides access to the cooking cavity 56 to allow for the placement and removal of items to be heated or cooked into and from the cooking cavity 56. The door assembly 58 in FIG. 1A rotates about a vertical rotational axis. Additionally, in the example illustrated in FIG. 1A, the microwave oven 50 is provided with a control panel 60, which is illustrated adjacent to the door assembly 58. The control panel 60 generally includes a user interface 62, which may include one or more input elements, such as push buttons, touch switches, and the like for setting operation parameters for controlling the microwave oven 50.

With reference to FIG. 1B, an additional configuration of the microwave oven 50 is illustrated. This configuration of the microwave oven 50 includes the outer housing 52 and the door assembly 58 operably coupled to the outer housing 52. The door assembly 58 is configured to rotate about a horizontal rotational axis to raise and close the cooking cavity 56 and lower and close the cooking cavity 56. The door assembly 58 includes a handle 78 to allow a user to move the door assembly 58. The microwave oven 50 also includes the control panel 60, which may be on the door assembly 58 or on the outer housing 52 proximate to the door assembly 58, such as above the door assembly 58.

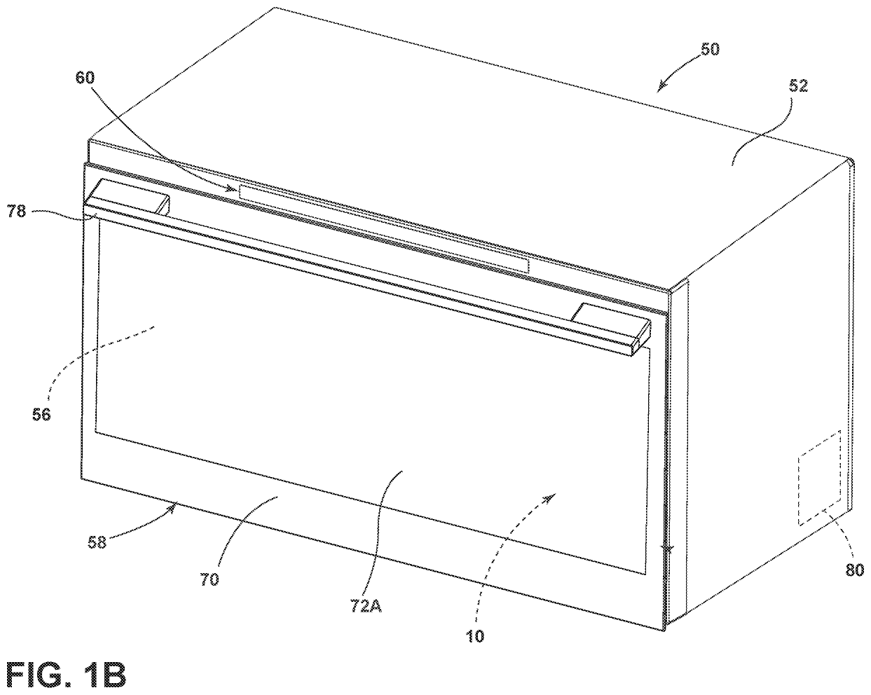

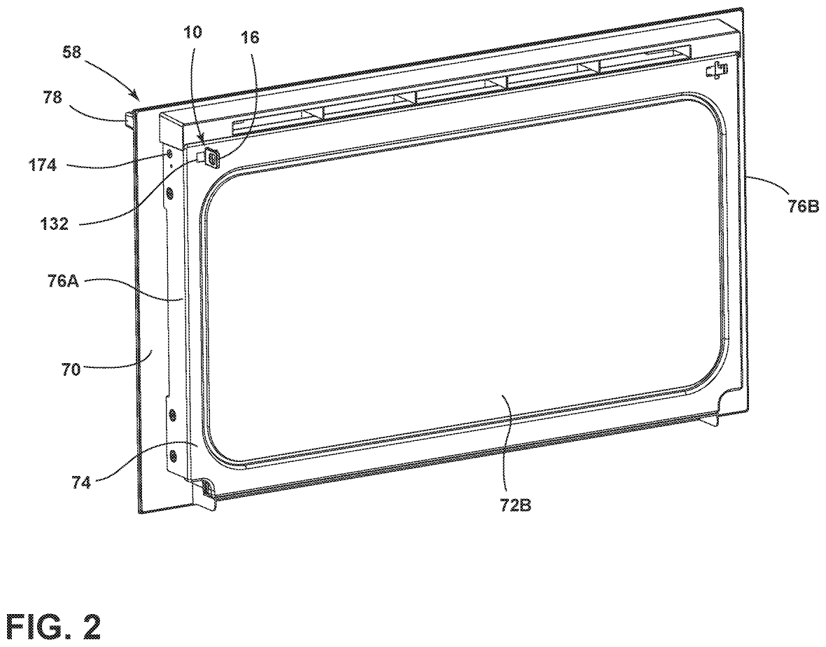

Referring to FIGS. 2 and 3, the door assembly 58 may include an outer panel 70, outer and inner glass panes 72A, 72B, an inner panel 74, and side panels 76A, 76B. The outer panel 70 is coupled with the outer glass pane 72A, and the inner panel 74 is coupled with the inner glass pane 72B. The side panels 76A, 76B extend between the outer panel 70 and the inner panel 74 such that the panels 70, 74, 76A, 76B collectively define an interior of the door assembly 58.

The glass panes 72A, 72B may align with one another and be partially or substantially transparent such that the cooking cavity 56 may be visible to a user through the glass panes 72A, 72B. The user may open the door assembly 58 by pressing a push button 77, such as in the configuration illustrated in FIG. 1A, or by pulling on a handle 78 attached to or defined by the door assembly 58, such as in the configuration illustrated in FIG. 1B. To close the door assembly 58, the user may push the door assembly 58 until the door assembly 58 is in a closed position. The door assembly 58 is generally retained closed by a latch or latch assembly.

The door assembly 58 also includes an inner frame 79 disposed within the interior, which can provide additional structural support for the door assembly 58 and components of the door assembly 58. For example, as illustrated in FIG. 3, the inner frame 79 includes multiple supports that couple to one another to form a generally rectangular shape extending about a perimeter of the glass panes 72A, 72B to reduce or prevent impingement on the view into the cooking cavity 56. The inner frame 79 can also provide support for the adjustment assembly 26. In the illustrated configuration, the base 12 forms a side support of the inner frame 79. It is also contemplated that the adjustment assembly 26 can be included in or form any portion of the inner frame 79 without departing from the teachings herein.

The illustrated configurations of the door assembly 58 are merely illustrative, with it being understood that various configurations of the door assembly 58 are possible without departing from the teachings herein. Similarly, the configuration of the outer housing 52 and the portions of the cooking cavity 56 not specifically discussed herein can vary according to the principles discussed herein and to accommodate the various features described in further detail herein.

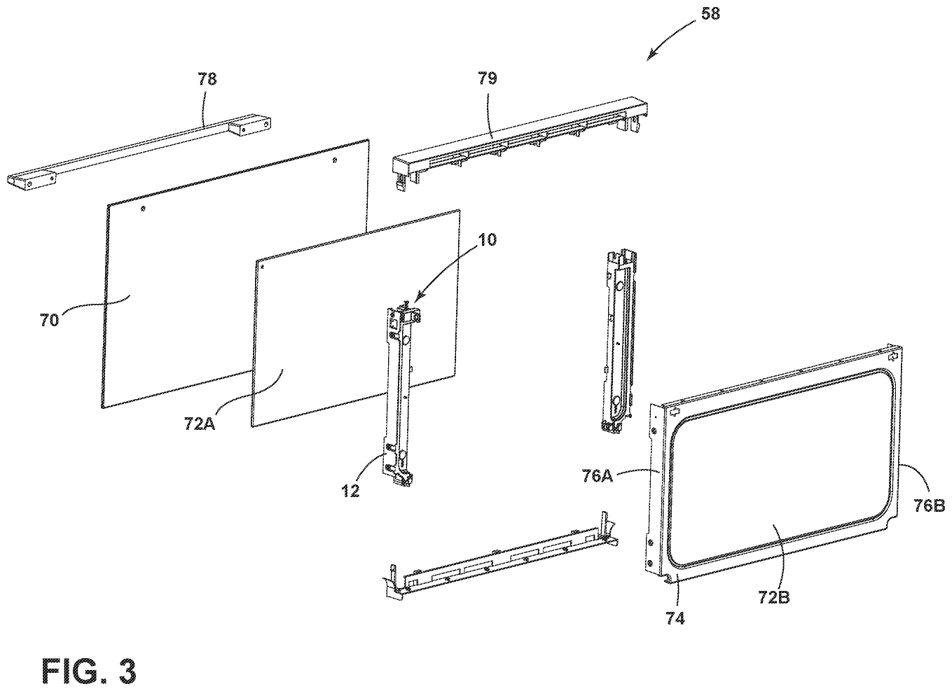

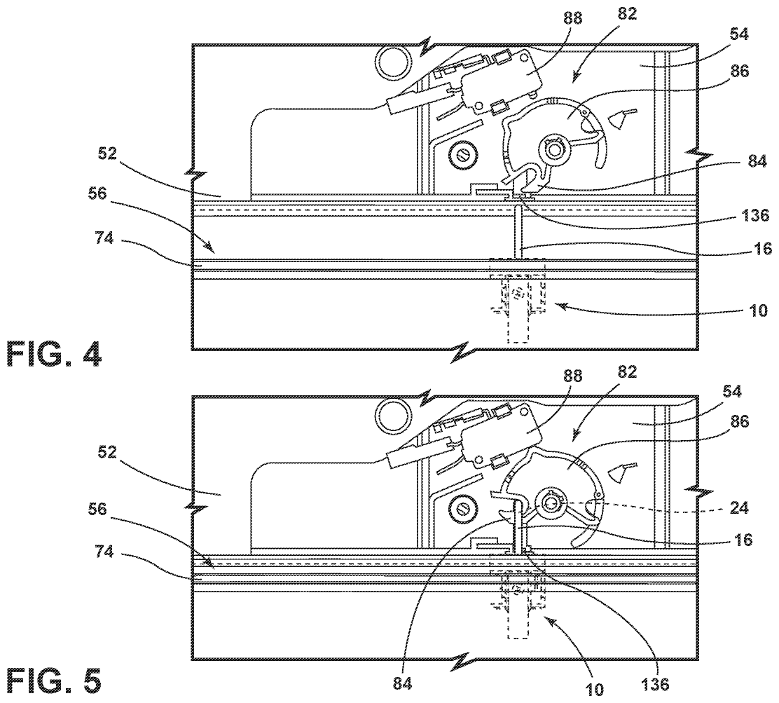

With reference again to FIGS. 1A and 1B, as well as FIGS. 4 and 5, the microwave oven 50 includes cooking or heating components and electronic components, such as a magnetron 80 for generating, directing, etc. microwaves. The microwave oven 50 may include any electronic components for generating microwaves or may include any components for heating or cooking food items. The microwaves are generally contained within the microwave oven 50, with minimal or no microwave emissions outside of or around the microwave oven 50. For example, microwave emissions around the microwave oven 50 may be less than about 5 mW/cm² or less than about 1 mW/cm². When the microwave oven 50 is operating (e.g., generating microwaves), the user can open the door assembly 58, which stops the generation of microwaves. This stopping is generally accomplished by a relationship between the door hook assembly 10 and an interlock system 82.

Referring still to FIGS. 4 and 5, the interlock system 82 is disposed within the outer housing 52 and may be supported by the inner housing 54 above the cooking cavity 56. The door hook assembly 10 operably engages with the interlock system 82. When the door assembly 58 is in the closed position, the door hook assembly 10 is engaged with the interlock system 82 and when the door assembly 58 is in an opened position, the door hook assembly 10 is disengaged from the interlock system 82. The state of the interlock system 82 affects the operation of the magnetron 80 as described herein.

The interlock system 82 may include a retaining element 84, such as a hook, on a rotating cam 86. The engagement element 22 of the door hook assembly 10 is configured to latch or engage with the retaining element 84 and cause the rotating cam 86 to rotate based on movement of the door hook assembly 10 that results from movement of the door assembly 58. The rotating cam 86 is rotated to engage with or disengage from an interlock switch 88. Accordingly, when the interlock switch 88 is closed, such that a circuit is closed, an electric current may travel to the magnetron 80, powering the magnetron 80 to generate microwaves. When the interlock system 82 is decoupled or disengaged from the door hook assembly 10, the rotating cam 86 is rotated away from the interlock switch 88 and, consequently, disengages from the interlock switch 88. Accordingly, in this state, the interlock switch 88 is open, such that the circuit is open and the electric current may be hindered or prevented from traveling to the magnetron 80, reducing or preventing power from the magnetron 80 and stopping the generation of microwaves. In this way, when the door assembly 58 is opened, power is generally prevented from reaching the magnetron 80. It is also contemplated that a door pin may also be used to directly engage the interlock switch 88 without departing from the teachings herein.

The closed position of the door assembly 58 and, as a result, the activated state of the magnetron 80, may be defined by an engagement between the door hook assembly 10 and the interlock system 82. As the door assembly 58 moves from the closed position to the opened position, a breaking point occurs when the rotating cam 86 disengages from the interlock switch 88 (i.e., a point of disengagement), where the interlock switch 88 changes status to stop the power to the magnetron 80. The breaking point is generally the last moment in which the interlock switch 88 changes from closed (e.g., providing power to the magnetron 80) to opened (e.g., stopping power to the magnetron 80) during movement of the door assembly 58 from the closed position to the opened position. Accordingly, there is a certain amount of distance the door assembly 58 moves before the breaking point occurs. The door hook assembly 10 can minimize this distance and range of motion of the door assembly 58 to cause the breaking point based on a position of the door hook 16 and, consequently, the relationship between the door hook assembly 10 and the interlock system 82, which affects operation of the magnetron 80 and the microwave oven 50 as described herein.

As the door hook assembly 10 decouples or disengages from the interlock system 82, the interlock switch 88 transitions from closed to open. In certain aspects where the door assembly 58 is configured with the push button 77 (see FIG. 1A) and the interlock system 82 includes the rotating cam 86, the interlock switch 88 may open before the door hook assembly 10 completely disengages with the interlock system 82. In such aspects, the act of pressing the push button 77 may cause the rotating cam 86 to rotate and disengage with the interlock switch 88, causing the interlock switch 88 to open before the retaining element 84 disengages from the door hook assembly 10. The disengaging of the interlock switch 88 before the disengagement between the retaining element 84 and the door hook assembly 10 is such that electric current is prevented from traveling to the magnetron 80 before the door hook assembly 10 completely disengages from the interlock system 82 and, consequently, before the door assembly 58 is opened.

In additional or alternative aspects, where the door assembly 58 is configured with the handle 78 (see FIG. 1B) to open the door assembly 58, the interlock switch 88 may open as the door hook assembly 10 disengages with the interlock system 82. In such aspects, the act of pulling the handle 78 may cause the door hook assembly 10 to disengage with the retaining element 84 as the interlock switch 88 opens. The opening of the interlock switch 88, as the door assembly 58 opens, is such that electric current is prevented from traveling to the heating element as the door hook assembly 10 disengages from the interlock system 82.

To allow the interlock system 82 to disengage from the door hook assembly 10 and the interlock switch 88 to open as the door assembly 58 begins to open, a fore-and-aft position of the door hook 16 relative to the door assembly 58 may be tuned or adjusted such that the breaking point occurs with minimal or minimized movement of the door assembly 58 toward the opened position. In other words, the position of the door hook assembly 10 can be adjusted to adjust the breaking point to be as close as possible to the fully closed position of the door assembly 58, where the fully closed position generally includes the rotating cam 86 being at a maximum rotation and the door assembly 58 abutting the outer housing 52.

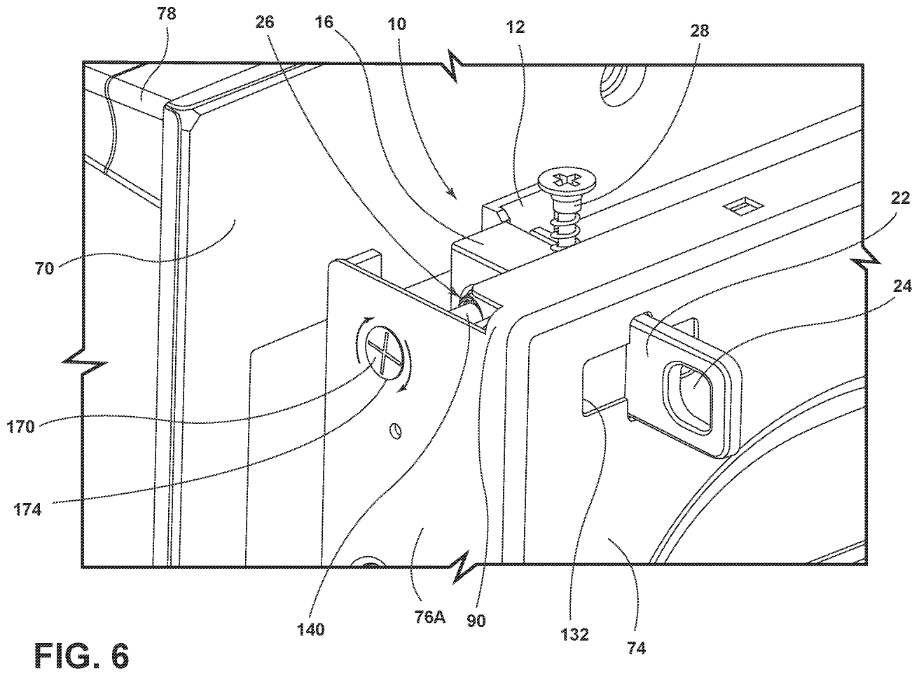

Referring now to FIGS. 6-14, the base 12 is coupled to the door assembly 58 to form a portion of the inner frame 79. In various examples, the base 12 can be coupled to the door assembly 58 via fasteners, coupling members, interlocking features, adhesive, etc. In various configurations, the base 12 may be also coupled to the inner panel 74 and/or the side panel 76A of the door assembly 58 in a similar manner. The base 12 is illustrated adjacent to the side panel 76A but may be positioned adjacent to the opposing side panel 76B without departing from the teachings herein.

In the illustrated example, the base 12 is disposed in the interior of the door assembly 58 between the inner panel 74 and the outer panel 70 in a corner 90 defined at the intersection of the inner panel 74 and the side panel 76A. The base 12 generally includes an inner or first support section 92 oriented toward the inner panel 74 and an outer or second support section 94 opposing the first support section 92 and oriented toward the outer panel 70. The base 12 also includes a first side section 96 oriented toward the side panel 76A and extending between the first and second support sections 92, 94 and a second side section 98 opposing the first side section 96, where the second side section 98 is oriented toward the side panel 76B and extends between the first and second support sections 92, 94.

A top edge 100 of the base 12 defines the upper opening 14 to receive the door hook 16. At least one or multiple of the sections 92, 94, 96, 98 of the base 12 may define the upper opening 14 without departing from the teachings herein. The door hook 16 is inserted into the base 12 via the upper opening 14. The door hook 16 is partially positioned within the base 12 via the upper opening 14 and at least partially extends out of the base 12.

As illustrated in FIG. 6, the first support section 92 abuts the inner panel 74 of the door assembly 58, and the first side section 96 abuts the side panel 76A of the door assembly 58. In various examples, the first support section 92 may have a protruding segment 102 that abuts the inner panel 74. The first support section 92 defines a first opening 104 through which the door hook 16 extends. The second support section 94 defines a second opening 106 that is aligned with the first opening 104 and may also be configured to receive the door hook 16. The door hook 16 can extend out of the interior of the base 12 via one or both of the first and second openings 104, 106. Moreover, the first and second openings 104, 106 generally permit the fore-and-aft translation of the door hook 16 relative to the base 12 and, consequently, the door assembly 58.

The door hook 16 includes the engagement portion 18 and a coupling portion 110, which collectively form a top surface 112 of the door hook 16. The engagement portion 18 includes abutting elements 130A, 130B extending outward in opposing side directions relative to the coupling portion 110. The abutting elements 130A, 130B form an “E” or backward “E” shape. This provides additional structural support to the door hook 16 while maximizing efficiency of the manufacturing process.

The engagement element 22 extends from the engagement portion 18 and away from the coupling portion 110. The engagement element 22 and the coupling portion 110 are generally aligned with a center portion of the engagement portion 18, forming a general “t” or plus (“+”) shape of the door hook 16. In this way, the abutting elements 130A, 130B extend substantially perpendicular to the engagement element 22 and the coupling portion 110.

The abutting elements 130A, 130B are configured to contact the protruding segment 102 of the first support section 92 as the door hook 16 is translated towards and/or past the second support section 94 (e.g., towards or through the second opening 106). The contact between the protruding segment 102 and the abutting elements 130A, 130B stops the linear translation of the door hook 16 in a direction towards the outer panel 70, defining a limit or range to the movement of the door hook 16. Further, the first support section 92 and the side section 96 define a receiving recess 134 where the abutting element 130A is positioned when the abutting elements 130A, 130B are in contact with the first support section 92.

In various examples, the abutting elements 130A, 130B are configured to move away from the first support section 92 and are configured to contact an inner surface of the inner panel 74 as the door hook 16 is translated towards and/or past the first support section 92. The contact between the inner surface and the abutting elements 130A, 130B stops the linear translation of the door hook 16 in a direction toward the inner panel 74. In certain aspects, this defined limit or movement provided by the contact between the abutting elements 130A, 130B with the protruding segment 102 and an inner surface of the inner panel 74 serves to provide a translational range in which the door hook 16 may be tuned while still allowing engagement with the interlock system 82 in a manner that rotates the rotating cam 86 to engage the interlock switch 88.

The engagement element 22 extends from the engagement portion 18, away from the base 12, and through an access aperture 132 defined by the inner panel 74 of the door assembly 58. In this way, the engagement element 22 extends through the inner panel 74 such that the engagement element 22 and the aperture 24 are visible when the door assembly 58 is in the opened position, as illustrated in FIG. 6. Generally, a width of the abutting elements 130A, 130B is greater than a width of the access aperture 132 such that the engagement element 22 may extend through the access aperture 132 while the abutting elements 130A, 130B engage the inner surface.

According to various aspects, as the door assembly 58 is moved to the closed position, the engagement element 22 extends into a receiving opening 136 defined by the outer housing 52 to engage the interlock system 82. The engagement element 22 is inserted into the outer housing 52 to engage the interlock system 82, such that the aperture 24 receives or engages the hook (e.g., the retaining element 84) of the rotating cam 86. As the door assembly 58 closes, the engagement element 22 moves further into the outer housing 52, causing the rotation of the rotating cam 86 and, consequently, activation of the interlock switch 88.

Referring still to FIGS. 6-11, the door hook 16 defines the first receiving aperture 20. As illustrated, the first receiving aperture 20 can be a top receiving aperture defined by the top surface 112 of the door hook 16. Generally, the first receiving aperture 20 is defined by the coupling portion 110 of the door hook 16 proximate to the abutting elements 130A, 130B. The first receiving aperture 20 may be a through-hole, a counterbore hole, a counter-sink hole, a spot-facing hole, or other similar aperture. The first receiving aperture 20 operably receives the door hook fastener 28, which may be the fixing screw or similar coupling member.

In such examples, the door hook 16 further defines either a threaded insert or threading defined on an inner wall surrounding the first receiving aperture 20 to mate with and engage the door hook fastener 28. Further, the base 12 defines a corresponding receiving aperture 138 that may be configured to align with the first receiving aperture 20. In certain positions of the door hook 16, the door hook fastener 28 may extend into the corresponding receiving aperture 138. Further, the corresponding receiving aperture 138 may have a size that allows the door hook fastener 28 to extend therein when the door hook 16 is in multiple positions. Additionally, it is generally contemplated that the first receiving aperture 20 may be defined in various portions and surfaces of the door hook 16, without departing from the teachings herein.

The door hook assembly 10 includes the adjustment assembly 26 for tuning or adjusting the position of the door hook 16 relative to the base 12, the door assembly 58, and the interlock system 82. The adjustment assembly 26 may be coupled to the base 12, the door assembly 58, and/or the door hook 16. In various examples, the adjustment assembly 26 may be coupled to the top surface 112 and/or the coupling portion 110 of the door hook 16. The adjustment assembly 26 is configured to tune and adjust a position of the door hook 16 relative to the door assembly 58 such that the breaking point between the door hook assembly 10 and the interlock system 82 may be adjusted.

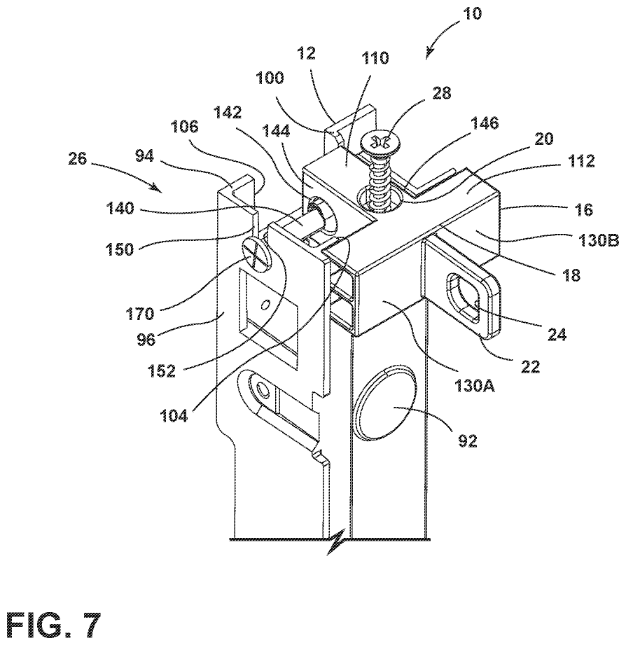

Referring still to FIGS. 6-11, in various aspects, the adjustment assembly 26 is configured as an offset or eccentric screw 140 for driving the linear translation of the door hook 16 in response to rotation of the eccentric screw 140. The coupling portion 110 of the door hook 16 defines a second receiving aperture 142 for receiving the eccentric screw 140. As illustrated in FIGS. 7-10, the second receiving aperture 142 is a side receiving aperture that extends through the coupling portion 110, from a first side surface 144 of the coupling portion 110 to a second side surface 146 of the coupling portion 110 that opposes the first side surface 144. The second receiving aperture 142 permits insertion of the eccentric screw 140 through the coupling portion 110.

In certain aspects, the second receiving aperture 142 may be a blind hole extending from either the first side surface 144 or the second side surface 146. In such examples, the second receiving aperture 142 may have a depth that allows for insertion of the eccentric screw 140 into the second receiving aperture 142. Accordingly, the second receiving aperture 142 extends generally normal to the first receiving aperture 20. In other aspects, the second receiving aperture 142 may extend parallel to or angled from the first receiving aperture 20. Additionally, it is generally contemplated that the second receiving aperture 142 may be defined in various locations of the door hook 16, without departing from the teachings herein. For example, the second receiving aperture 142 may be a top receiving aperture, while the first receiving aperture 20 may be a side receiving aperture.

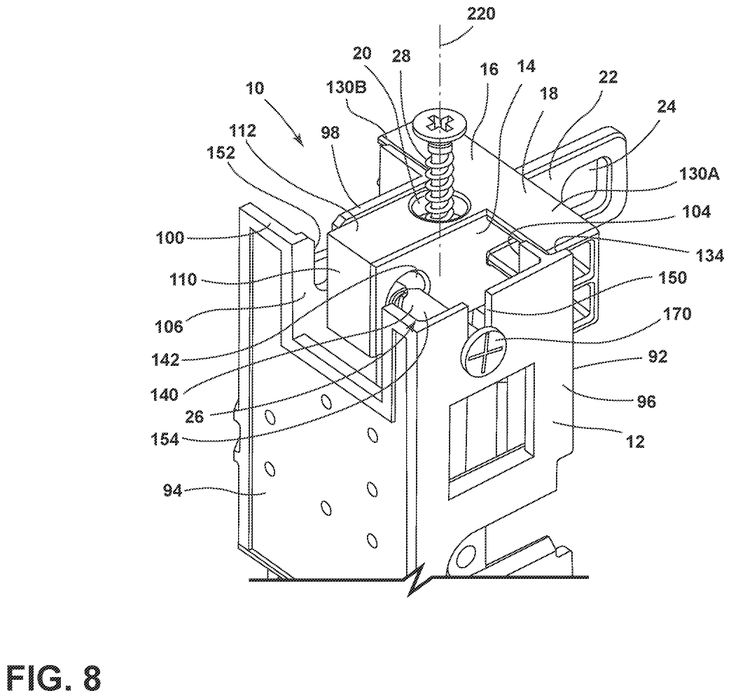

As illustrated in FIGS. 7 and 8, the eccentric screw 140 is received or positioned in a first slot 150 and a second slot 152 defined by the base 12. In various examples, the first side section 96 defines the first slot 150, and the second side section 98 defines the second slot 152, which is generally aligned with the first slot 150. The first slot 150 is configured to receive a proximal portion 154 of the eccentric screw 140, and the second slot 152 is configured to receive a distal portion 156 of the eccentric screw 140 on an opposing side of the door hook 16. Accordingly, the first slot 150 and the second slot 152 each have a width that is at least greater than a width of the proximal portion 154 and the distal portion 156, respectively.

In various examples, the second receiving aperture 142 may be defined in such a way that a middle portion 160 of the eccentric screw 140 is configured to be disposed within the door hook 16 to engage at least opposing portions 162A, 162B of an inner wall 164. The inner wall 164 is defined around an outer periphery of the second receiving aperture 142. The opposing portions 162A, 162B generally form inner and outer or front and rear portions of the inner wall 164. The second receiving aperture 142 may be defined in such a manner that the middle portion 160 of the eccentric screw 140 has a sliding engagement with the inner wall 164 and remains in contact with the inner wall 164 as the eccentric screw 140 rotates.

In the example illustrated in FIGS. 6-11, the adjustment assembly 26 is configured as the eccentric screw 140 for tuning the position of the door hook 16 relative to the door assembly 58. The eccentric screw 140 is inserted through the first slot 150, the second receiving aperture 142, and the second slot 152. Often, the eccentric screw 140 can be inserted through the side panel 76A, allowing rotation of the eccentric screw 140 from outside the door assembly 58, which is advantageous for adjusting the position of the door hook 16 during and after manufacturing processes.

The proximal portion 154 of the eccentric screw 140 generally includes a screw head 170 that is configured to abut the side panel 76A or the first side section 96 when the eccentric screw 140 is fully inserted. The eccentric screw 140 also includes the distal portion 156 coaxial with the proximal portion 154 along a rotational axis 172, which is generally a central axis of the proximal and distal portions 154, 156 and the screw head 170. The proximal portion 154 is spaced from the distal portion 156 by the middle portion 160 disposed therebetween.

The middle portion 160 is offset from the proximal portion 154 and the distal portion 156, being disposed partially along the rotational axis 172 but not coaxial with the proximal portion 154 and the distal portion 156. Accordingly, a central axis of the middle portion 160 is spaced from and parallel to the rotational axis 172. The offset middle portion 160 rotates around the rotational axis 172, with the offset nature of the middle portion 160 causing the engagement with the inner wall 164. In this way, this configuration allows for alignment of the door hook 16 via the eccentric screw 140 engaging and moving the door hook 16 as the eccentric screw 140 is rotated. Moreover, the middle portion 160 may be entirely offset from the rotational axis 172 without departing from the teachings herein.

As illustrated in FIGS. 7-9, the proximal portion 154 is partially disposed within the first slot 150 and extends between the first side section 96 of the base 12 and the first side surface 144 of the coupling portion 110. The distal portion 156 extends between the second side section 98 of the base 12 and the second side surface 146 of the door hook 16 such that the distal portion 156 is disposed within or proximate to the second slot 152. In some examples, the distal portion 156 may include an additional element, such as a pin or a nut, that assists in retaining the proximal portion 154 and/or the distal portion 156 in respective positions. The middle portion 160 is generally disposed within the second receiving aperture 142 and is at least partially in contact with the inner wall 164 to drive movement of the door hook 16.

In various examples, the middle portion 160 of the eccentric screw 140 is in continuous contact with the inner wall 164. In such examples, the offset relationship between the middle portion 160 compared to the proximal portion 154 and the distal portion 156 and the rotation of the eccentric screw 140 provides a cammed interface that exerts a force on the door hook 16, which causes linear translation of the door hook 16. The linear translation is relative to the fore-and-aft, or depth, of the door assembly 58. The rotational movement of the eccentric screw 140 is translated into linear motion of the door hook 16 through the camming engagement between the inner wall 164 and the middle portion 160 of the eccentric screw 140.

In certain aspects, the continuous contact between the eccentric screw 140 and the door hook 16 can move the door hook 16 in two opposing directions based on the rotational direction of the eccentric screw 140. For example, when the eccentric screw 140 is rotated clockwise, the door hook 16 may be moved in a first direction, such as towards the inner panel 74. When the eccentric screw 140 is rotated counterclockwise, the door hook 16 may be moved in a second direction, such as towards the outer panel 70. Based on the configuration of the eccentric screw 140 and the relationship between the eccentric screw 140 and the door hook 16, different rotation of the eccentric screw 140 can result in different linear movement of the door hook 16.

In additional non-limiting examples, the second receiving aperture 142 may be defined in such a manner that the eccentric screw 140 contacts the opposing portions 162A, 162B of the inner wall 164, which are generally front and rear portions to drive the fore-and-aft movement of the door hook 16. In such examples, the inner wall 164 may define an oval or oblong shape where the eccentric screw 140 may be spaced from upper and lower portions of the inner wall 164 during rotation. The eccentric screw 140 may permit the translation of the door hook 16 once the middle portion 160 contacts either of the opposing portions 162A, 162B. Through either continuous or intermittent contact between the middle portion 160 and the inner wall 164, the user may adjust a position of the door hook 16 relative to the base 12 and the inner panel 74. Additionally, it is generally contemplated that the eccentric screw 140 may contact various portions of the inner wall 164 and that the door hook 16 may move in a like direction of the portion of the inner wall 164 contacted, without departing from the teachings herein.

To tune the position of the door hook 16 via the eccentric screw 140, the user may rotate the eccentric screw 140 about the rotational axis 172 via a driver or tool that engages the screw head 170. In various examples, the driver may be a screwdriver, and the screw head 170 may define a cross-section that engages with an end of the screwdriver that has a like or mating design. It is also generally contemplated that the screw head 170 may have various designs, so long as the user can drive the rotational movement of the eccentric screw 140.

In various examples, the user may access the screw head 170 via an access opening 174 that is defined by the side panel 76A of the door assembly 58. The access opening 174 may have a width that is at least equal to or greater than a width of the screw head 170 to allow insertion of the eccentric screw 140 therethrough. However, the access opening 174 may have a width smaller than the screw head 170 and with a width to receive the driver to retain the eccentric screw 140 in the interior of the door assembly 58. Additionally or alternatively, the screw head 170 may be disposed outside of the side panel 76A for access to the screw head 170 with the eccentric screw 140 extending through the access opening 174.

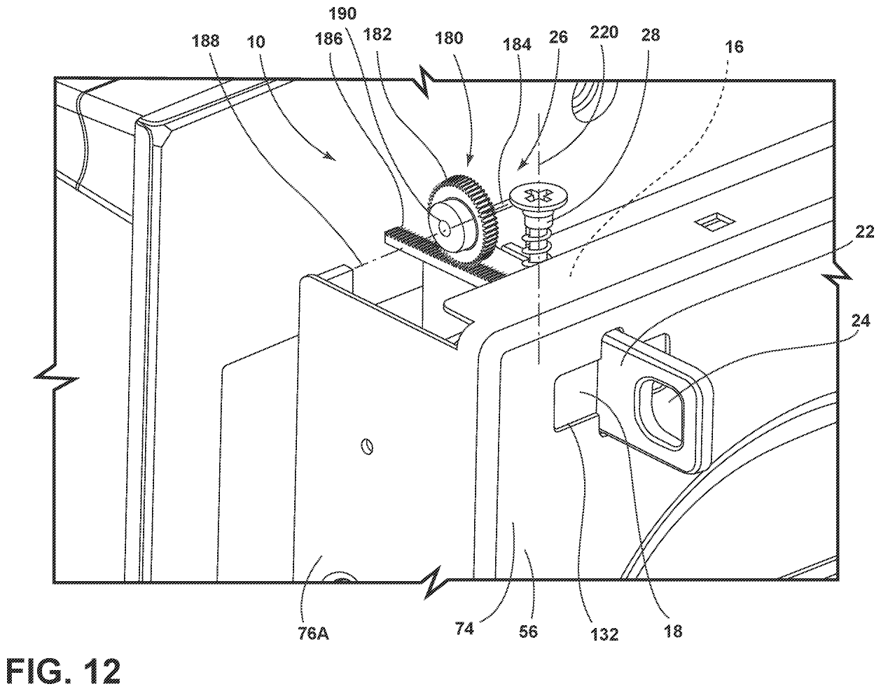

Referring to FIG. 12, the adjustment assembly 26 may be configured as a rack and pinion gear set 180 to tune the position of the door hook 16. In various examples, the rack and pinion gear set 180 includes a pinion 182 rotatably coupled to the door assembly 58 via an intermediate shaft 184, and a rack 186 coupled to the door hook 16. The pinion 182 may be a normal spur gear or corrected spur gear with a teeth ratio that coincides with teeth of the rack 186. The rack 186 may be coupled to or integrally formed with the door hook 16, and the rack 186 may have a teeth ratio that coincides with teeth of the pinion 182. Additionally, the rack and pinion gear set 180 may define various teeth ratios such that rotation of the pinion 182 at a single speed may drive a linear movement of the rack 186 and, consequently, linear movement of the door hook 16 at varying speeds, depending on the respective gear ratio between the rack and pinion gear set 180.

The user may rotate the pinion 182 about a rotational axis 188 of the pinion 182 to adjust or tune the door hook 16. In various examples, the rotational axis 188 may extend through a center point of the intermediate shaft 184 such that the pinion 182 is rotating about the intermediate shaft 184. The pinion 182 may be rotated, and the door hook 16 tuned, via a tool or driver, such as a screwdriver or Allen key, that can engage with a receiver 190 defined by the pinion 182. The user can apply a rotational force upon the pinion 182 with the tool. In such examples, the receiver 190 may be accessed by opening the door assembly 58 and engaging with the pinion 182 via the access opening 174.

Additionally or alternatively, a coupling feature may be coupled to the pinion 182 or the intermediate shaft 184 may extend through the pinion 182. In such examples, the coupling feature or the intermediate shaft 184 may extend toward or through the access opening 174 to be engaged by the user.

In further non-limiting examples, the pinion 182 may be rotated, and the door hook 16 tuned, by a user grasping the door hook 16 and applying a pushing or pulling force along a depth of the door assembly 58. In such examples, the pushing or pulling of the door hook 16 permits translation of the door hook 16 as the rack 186 drives the pinion 182 and permits rotation of the pinion 182. Additionally, it is also contemplated that once tuning has been completed, the rack and pinion gear set 180 may include a stop, such as a pawl, or other stopping feature, that may inhibit rotation of the pinion 182 and/or travel of the rack 186 and assist in keeping the door hook 16 in the tuned position while the door hook fastener 28 is being adjusted to the fixed condition.

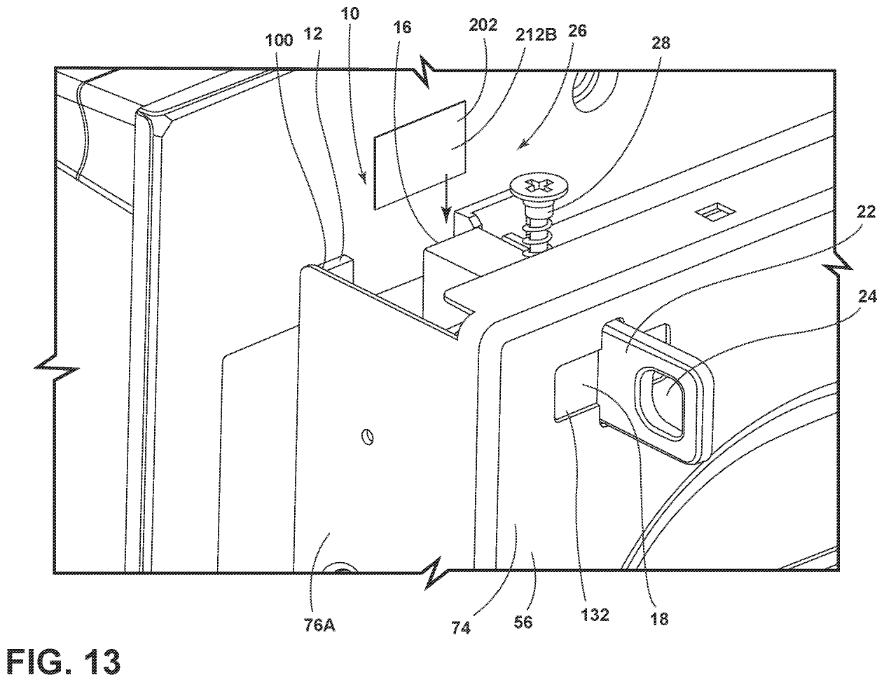

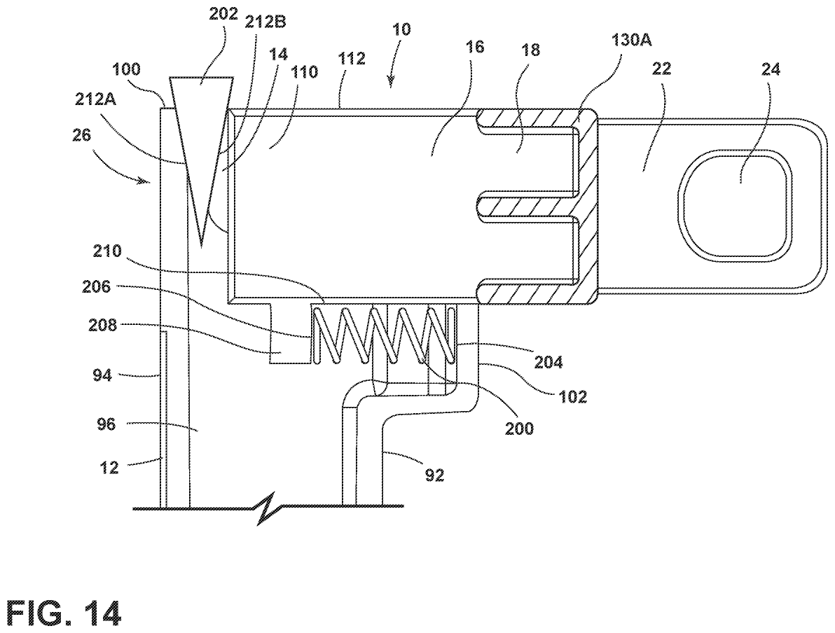

Referring to FIGS. 13 and 14, the adjustment assembly 26 may be configured as a biasing member 200 and at least one insert 202 to tune the position of the door hook 16. The biasing member 200 is illustrated as a spring 200 that is housed within the base 12 but may be any feature that exerts a biasing force. The spring 200 includes a first end 204 that contacts or is coupled to the first support section 92 and a second end 206 that contacts or is coupled to the door hook 16. In the illustrated example, the door hook 16 includes a protrusion 208 extending from a bottom portion 210 thereof, and the second end 206 of the spring 200 is coupled to the protrusion 208. The spring 200 may then provide a biasing force that drives or biases the door hook 16 towards the second support section 94.

Each insert 202 may be disposed in the upper opening 14 of the base 12 and may be disposed between the coupling portion 110 of the door hook 16 and the second support section 94 of the base 12. In various examples, each insert 202 may include opposing sides 212A, 212B. The opposing sides 212A, 212B may face the coupling portion 110 and the second support section 94, respectively, and have a width that is less than a defined width of the upper opening 14. In additional examples, the width may be greater than a width of the second opening 106 such that the insert 202 extends beyond edges that define the second opening 106 to abut the second support section 94. In this configuration, the insert 202 is maintained within the upper opening 14 of the base 12. Additionally, in various examples, the second opening 106 may be omitted from the second support section 94, and the insert 202 is then disposed between the coupling portion 110 of the door hook 16 and the second support section 94.

One or both of the opposing sides 212A, 212B may define a textured surface. The textured surface of each side 212A, 212B of the insert 202 may increase friction between the insert 202 and another element, which may be the door hook 16, the base 12, or another insert 202. By way of example, not limitation, the textured surface may be a ribbed surface, a roughened surface, and/or a knurled surface that increases friction between the textured surface and another member. In such examples, the increased friction provides a retaining or holding force that at least assists in retaining the insert 202 in position and/or in a static condition.

In additional non-limiting examples, one or both of the opposing sides 212A, 212B may define a smooth surface, such as a machined or formed surface, that decreases friction between the opposing sides 212A, 212B and another element. The smooth surface can assist in the insertion of the insert 202 into the upper opening 14 and between components, such as the door hook 16 and the base 12. Moreover, a portion of each side 212A, 212B may be smooth for assisting with insertion and have textured portions for maintaining the position of the insert 202. Additionally, it is generally contemplated that each insert 202 may be constructed of various materials having various properties, such as a metal, a plastic, a composite, or a combination thereof.

Referring still to FIGS. 13 and 14, the inserts 202 may be used to provide an opposing force that linearly adjusts or tunes the door hook 16 against the biasing force provided by the biasing member 200. It is generally contemplated that multiple inserts 202 having the same or different physical properties may be used to adjust the door hook 16 against the biasing force. The different physical properties may include but are not limited to, smooth surfaces, textured surfaces, resistance to deformation, elastic deformation, compression, etc. In this way, inserts 202 with a combination of properties may be used to customize and tune the position of the door hook 16, as well as adjust the precision of the tuning of the door hook 16.

It is also generally contemplated that the number, shape, and/or size of the inserts 202 adjusting the linear translation of the door hook 16 may adjust and tune the door hook 16 to varying degrees. Accordingly, larger inserts 202 or a plurality of inserts 202 may drive the door hook 16 further toward the first support section 92 against the biasing force of the biasing member 200 to a larger degree than a single or smaller insert 202. Upon removal of the insert 202 or inserts 202, the biasing force adjusts the door hook 16 towards the second support section 94. Moreover, the biasing force is configured to retain engagement between the door hook 16 and the insert 202. This configuration assists in retaining the insert 202 in position between the door hook 16 and the base 12 with the biasing force acting on the insert via the door hook 16.

In various aspects, such as the configuration illustrated in FIG. 14, the insert 202 may be an angular or angled insert, such as a triangular or wedge insert 202. In such examples, the depth of insertion of the insert 202 into the base 12 determines a distance between the coupling portion 110 of the door hook 16 and the second support section 94. For example, if the insert 202 is a triangular or wedge insert 202 and a thinner portion of the triangular insert is a leading edge being inserted, the distance between the coupling portion 110 and the second support section 94 increases as the insertion depth increases, as illustrated in FIG. 14. The insert 202 may also be pyramidal, conical, frusto-conical, or similar shapes where one end is thicker or larger than the opposing end. Additionally, in such examples, the insert 202 may be constructed of a softer material that permits deformation at contact points between the insert 202 and the coupling portion 110 and/or second support section 94, such as a plastic having a low durometer.

In additional non-limiting examples, the door hook 16 may be adjusted via a plurality of inserts 202, where the addition of each insert 202 increases the distance between the coupling portion 110 and the second support section 94. For example, the opposing sides 212A, 212B of each of the plurality of inserts 202 may be parallel such that each insert 202 may be side stacked upon or next to each other. The increase in side-stack thickness likewise corresponds to an increase in distance between the coupling portion 110 and the second support section 94 against the biasing force of the biasing member 200.

Referring again to FIGS. 6-14, once the position of the door hook 16 has been tuned by the adjustment assembly 26 to a select position, the door hook 16 is fastened to the base 12 via the door hook fastener 28. The door hook fastener 28 is operable between the unfixed condition and the fixed condition. In various examples, the door hook fastener 28 may be the fixing screw 28. The fixing screw 28 is in the unfixed condition when it is spaced from either the threaded insert or a threaded inner wall or not fully installed therein. In this way, When the fixing screw 28 is in the unfixed condition, the door hook 16 may freely translate along the base 12, and the position of the door hook 16 can be adjusted or tuned.

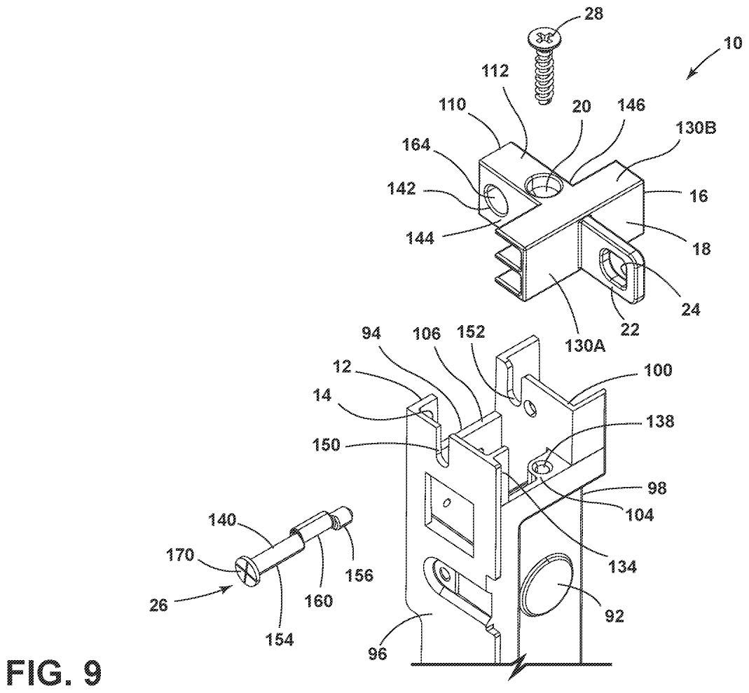

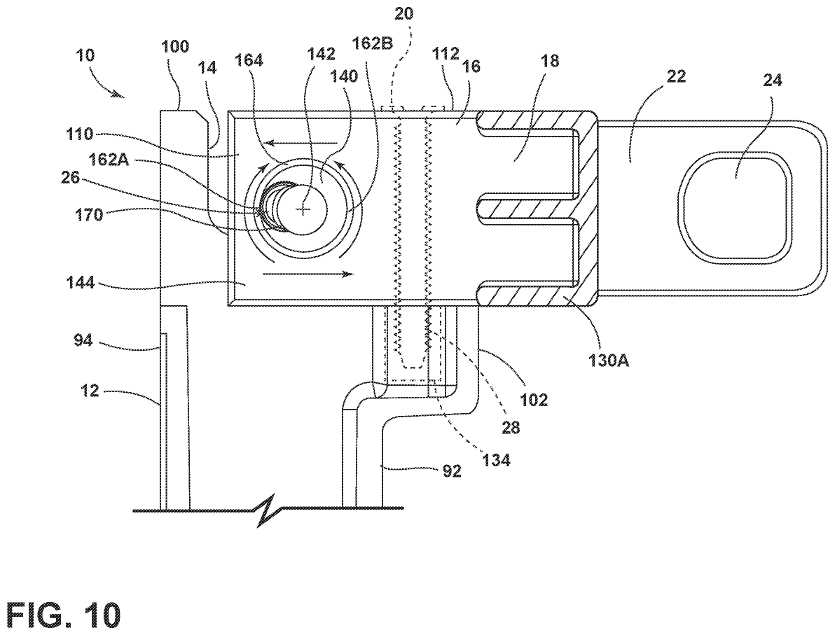

The fixing screw 28 can be moved in the fixed condition when the screw rotates downward, into, or toward the base 12 about a rotational axis 220. In the illustrated configurations, the rotational axis 220 is generally perpendicular to the respective rotational axis 172, 188. The threading on the fixing screw 28 engages with either the threaded insert or the threaded inner wall of the door hook 16 and with threading defined on the base 12 (see FIGS. 9 and 10). When the fixing screw 28 is in the fixed condition, the door hook 16 is fastened to the base 12 in a fixed position, where translation of the door hook 16 is minimized or prevented. This retains the door hook 16 in the selected position to determine the breaking point with the interlock system 82.

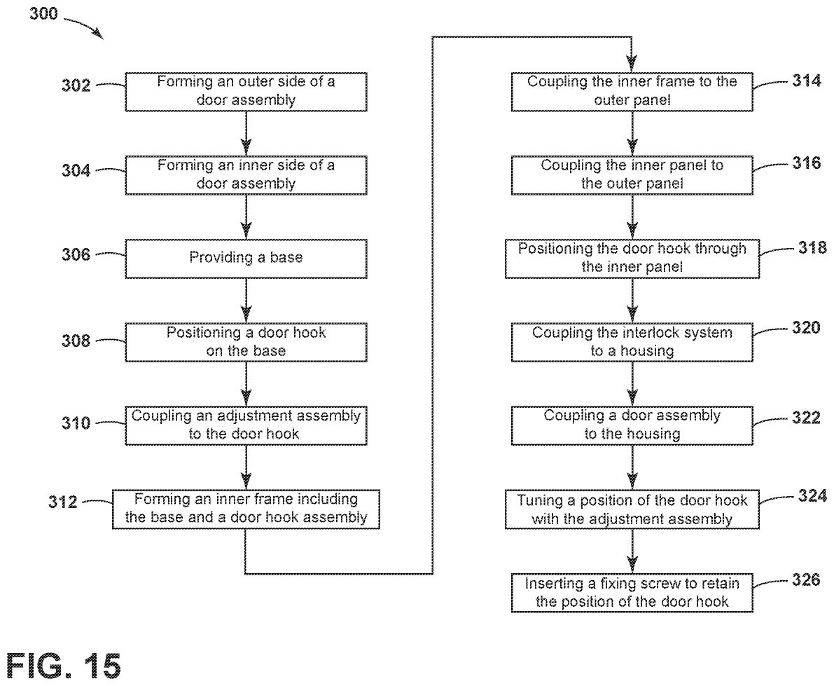

With reference to FIG. 15, as well as FIGS. 1A-14, a method 300 of manufacturing the cooking appliance 50 includes step 302 of forming an outer side of the door assembly 58 by coupling the outer panel 70 with the outer glass pane 72A. Step 304 includes forming an inner side of the door assembly 58 by coupling the inner panel 74 with the inner glass pane 72B. Step 304 may also include coupling the side panels 76A, 76B to the inner panel 74. Further, step 304 can include forming the access opening 174 in the side panel 76A.

In step 306, the base 12 is provided with the upper opening 14. In step 308, the door hook 16 is inserted into the upper opening 14 and supported by the base 12. In certain aspects, the door hook 16 is held in a generally horizontal position by the base 12. The door hook 16 is positioned for the engagement portion 18 to be positioned outside the base 12, and the coupling portion 110 to be positioned inside the base 12.

In step 310, the adjustment assembly 26 is coupled to the door hook 16 to form the door hook assembly 26 with the base 12. In certain aspects, such as for the configuration illustrated in FIGS. 6-11, the eccentric screw 140 is inserted through the first slot 150, through the second receiving aperture 142, and/or through the second slot 152. The eccentric screw 140 may assist in retaining the door hook 16 in the horizontal position. Further, in step 310, a nut may be coupled to the eccentric screw 140 to retain the engagement between the eccentric screw 140 and the door hook 16.

In additional or alternative aspects, such as the configuration illustrated in FIG. 12, step 310 includes coupling the rack 186 to the door hook 16 and the pinion 182 to the intermediate shaft 184. The intermediate shaft 184 may be coupled to other components of the door assembly 58. Further, the door hook 16 may be formed with the rack 186.

In further non-limiting examples, such as the configuration illustrated in FIGS. 13 and 14, the biasing member 200 may be coupled to the base 12 and the door hook 16 in step 310. The door hook 16 can be repositioned in the base 12 with the biasing force acting on the door hook 16.

In step 312, the inner frame 79 is formed, including the base 12 with the door hook 16 and the adjustment assembly 26 (e.g., the door hook assembly 10). The coupling of the various supports to form the inner frame 79 may generally retain the door hook assembly 10 in the inner frame 79. In step 314, the inner frame 79 is coupled to the outer panel 70. In step 316, the inner panel 74 and the side panels 76A, 76B are coupled to the outer panel 70 over the door hook assembly 10 and the inner frame 79. In step 318, the engagement element 22 of the door hook 16 extends through the access aperture 132 defined by the inner panel 74. Further, the inner frame 79 may be coupled to the inner panel 74 and/or the side panels 76A, 76B. Steps 302-318 may generally be a method for forming the door assembly 58.

In step 320, the interlock system 82 is coupled to the inner housing 54 and positioned in the outer housing 52. The outer housing 52 includes the receiving opening 136 to receive the engagement element 22. In step 322, the door assembly 58 is coupled to the outer housing 52.

In step 324, the position of the door hook 16 is adjusted or tuned. The position of the door hook 16 can be adjusted by rotating the eccentric screw 140 (see FIGS. 6-11), rotating the pinion 182 (see FIG. 12), and/or by adding or removing inserts 202 between the door hook 16 and the base 12 (see FIGS. 13 and 14). The position of the door hook 16 can be tuned to minimize a distance that the door assembly 58 moves from the fully closed position to the breaking point for the interlock system 82.

In step 326, the fixing screw 28 is inserted into the first receiving aperture 20 to fix the door hook 16 in position relative to the base 12 and, consequently, the door assembly 58, as well as fix the relationship between the door hook 16 and the interlock system 82. The steps 302-326 of method 300 may be performed in any order, performed simultaneously, performed in succession, repeated, omitted, etc. without departing from the teachings herein. Further, a portion of the method 300 such as, but not limited to, steps 318-326 may be referred to as a method of tuning or adjusting the door hook 16.

As described herein, the interlock system 82 is disposed in the outer housing 52, and the door hook assembly 10 is disposed in the door assembly 58. It is also contemplated that the door hook assembly 10 may be positioned in the outer housing 52 while the interlock system 82 is disposed in the door, without departing from the teachings herein. In such examples, the engagement element 22 extends out of the outer housing 52 and is configured to extend into the door assembly 58. In such examples, the access opening 174 may be defined on the outer housing 52. The adjustment assembly 26 may be coupled to the outer housing 52 or the inner housing 54.

Referring to FIGS. 1A-15, the door hook assembly 10 provides the user with linear adjustability between the door assembly 58 and the interlock system 82. This linear adjustability can assist in adjusting the breaking point between the door hook assembly 10 and the interlock system 82 such that the breaking point occurs earlier to stop the electric current from traveling to the magnetron 80 or other heating elements and/or electronic components.

In particular, the use of the adjustment assembly 26 provides the user with the opportunity to effectively adjust a position of the door hook 16 in the fore-and-aft direction relative to the door assembly 58. By way of example, the user may be able to quickly adjust the position of the door hook 16 relative to the door assembly 58 by rotating the eccentric screw 140. As the eccentric screw 140 rotates, the middle portion 160 may contact the inner wall 164 that encompasses the second receiving aperture 142 and exerts a force upon the door hook 16. The force exerted by the eccentric screw 140 can then drive the linear translation of the door hook 16 such that the position of the door hook 16 relative to door assembly 58 is tuned. Once the user has tuned the position of the door hook 16, the user may then fix the door hook 16 to the base 12 by moving the door hook fastener 28 from the unfixed condition to the fixed condition. The tuning may also be accomplished via the rack and pinion gear set 180 or the inserts 202 and fixed in a similar manner with the fixing screw 28.

The linear adjustability of the door hook assembly 10 further provides for greater variance in tolerances, and tolerance stacking of various components of the microwave oven 50. For example, the door hook 16 of the door hook assembly 10 may be linearly adjusted and tuned relative to the interlock system 82 after other aspects of the microwave oven 50 have been assembled and/or after a manufacturing process for the cooking appliance 50 is complete. Minimal components, including a portion of the inner frame 79 may be removed to adjust the fixing screw 28 to the unfixed condition to tune the door hook 16. Additionally, it also contemplated that while the door hook assembly 10 is provided in the door assembly 58, the door hook assembly 10 may be coupled to and disposed within the outer housing 52 and may engage with the interlock system 82 disposed within the door assembly 58.

Use of the presently disclosed device may provide a variety of advantages. For example, the use of at least one of the eccentric screw 140, the rack and pinion gear set 180, and/or the biasing member 200 and the insert 202 allows for a quick and efficient adjustment of the door hook 16 to define the closed position of the door assembly 58. Additionally, the linear adjustment provided by the door hook assembly 10 advantageously allows the user to linearly adjust and redefine the closed position after other aspects of the microwave oven 50 have been assembled, which in turn allows for greater variance in tolerances and tolerance stacking. Further, the position of the door hook 16 can be tuned multiple times, including after completion of the manufacturing process. Moreover, the tuning of the position of the door hook 16 can minimize the movement of the door assembly 58 between the fully closed position and the breaking point for the interlock system 82. Additional benefits or advantages of using this device may also be realized and/or achieved.

The device disclosed herein is further summarized in the following paragraphs and is further characterized by combinations of any and all of the various aspects described therein.

According to an aspect of the present disclosure, a door hook assembly for a cooking appliance includes a base that defines an opening. A door hook is disposed within the opening. The door hook includes an engagement portion and defines a first receiving aperture. The engagement portion includes an engagement element that defines an aperture. An adjustment assembly is coupled to the door hook. The adjustment assembly is configured to drive a linear translation of the door hook. A door hook fastener is disposed within the first receiving aperture. The door hook fastener is movable between an unfixed condition and a fixed condition. The door hook is linearly translatable relative to the base when the door hook is in the unfixed condition. The door hook is fixed to the base when the door hook is in the fixed condition.

According to another aspect of the present disclosure, a door hook defines a second receiving aperture. An adjustment assembly includes an eccentric screw disposed in the second receiving aperture. A rotational movement of the eccentric screw drives linear translation of the door hook.

According to another aspect of the present disclosure, an eccentric screw includes a proximal portion having a screw head, a distal portion coaxial with the proximal portion along a first axis, and a middle portion between and offset from the proximal portion and the distal portion.

According to another aspect of the present disclosure, a door hook includes an inner sidewall surrounding an outer periphery of a second receiving aperture. A middle portion operably contacts opposing portions of the inner sidewall during rotation to drive linear translation of the door hook.

According to another aspect of the present disclosure, an adjustment assembly includes a rack and pinion gear set. The rack and pinion gear set includes a rack coupled to a door hook and a pinion operably coupled to the rack. A rotational movement of the pinion about a first axis drives linear translation of the door hook via engagement with the rack.

According to another aspect of the present disclosure, a door hook fastener is movable between an unfixed condition and a fixed condition along a second axis. The second axis is generally perpendicular to a first axis.

According to another aspect of the present disclosure, an adjustment assembly includes a biasing member disposed within a base and an insert disposed between a coupling portion of a door hook and a second support section of the base. The biasing member is coupled to the door hook and provides a biasing force that biases the door hook towards the second support section. The insert provides an opposing force that drives the door hook towards a first support section of the base.

According to another aspect of the present disclosure, a door hook includes an engagement portion having a pair of outwardly extending abutting elements. The abutting elements are substantially perpendicular relative to an engagement element and are configured to limit the linear translation of the door hook.

According to another aspect of the present disclosure, the first receiving aperture is defined on a top surface of the door hook.

According to another aspect of the present disclosure, the first receiving aperture is defined on a side surface of the door hook.

According to an aspect of the present disclosure, a cooking appliance includes an outer housing defining a receiving aperture and an interlock system disposed within the outer housing proximate to the interlock system. The interlock system includes a rotating cam and an interlock switch. A door assembly is operably coupled to the outer housing. The door assembly includes an inner panel defining an access aperture and a base operably coupled to the inner panel. The base defines an upper opening. The door assembly also includes a door hook disposed in the upper opening of the base and an adjustment assembly operably coupled to the door hook. The adjustment assembly is configured to linearly translate the door hook relative to the inner panel to adjust a position of the door hook. The position of the door hook adjusts an engagement between the door hook and the interlock system.

According to an aspect of the present disclosure, a door hook is configured to rotate a rotating cam to engage an interlock switch when a door assembly is in a closed position. The door hook is configured to rotate the rotating cam to disengage from the interlock switch as the door assembly is moved to an opened position.

According to an aspect of the present disclosure, a magnetron is configured to generate microwaves. A point of disengagement between an interlock switch and a rotating cam defines a breaking point for stopping power to the magnetron. A position of a door hook determines the breaking point.

According to an aspect of the present disclosure, an adjustment assembly includes an eccentric screw having an offset portion. The eccentric screw extends through a door hook. Rotation of the eccentric screw is configured to drive a linear translation of a door hook.

According to an aspect of the present disclosure, an adjustment assembly includes a rack coupled to a door hook and a pinion operably coupled to a door assembly. Rotation of the pinion drives movement of the rack and, consequently, a linear translation of a door hook.

According to an aspect of the present disclosure, an adjustment assembly includes a biasing member extending between a door hook and a first support section of a base. The adjustment assembly further includes an insert configured to be positioned between a second support section of the base and the door hook to drive a linear translation of the door hook against a biasing force.

According to an aspect of the present disclosure, a door assembly includes a fixing fastener configured to extend through a door hook and fix a position of the door hook relative to a base and, consequently, set a relationship between the door hook and an interlock system.

According to an aspect of the present disclosure, a position of a door hook determines a distance of movement of a door assembly from a closed position to an opened position that causes disengagement between an interlock switch and a rotating cam to affect operation of a cooking appliance.

According to an aspect of the present disclosure, a cooking appliance includes a housing, an interlock system disposed within the housing, a door assembly including an inner panel defining an access aperture, and a door hook assembly operably coupled to the door assembly. The door hook assembly includes a base defining an upper opening and a door hook positioned within the upper opening. The door hook includes an engagement element configured to extend into the housing to engage the interlock system when the door assembly is in a closed position. The door hook assembly also includes an adjustment assembly operably coupled to the door hook. The adjustment assembly is configured to drive linear translation of the door hook to adjust a position of the door hook relative to the base. The position of the door hook adjusts a relationship between the door hook and an interlock switch as the door assembly is moved from the closed position to an opened position.

According to an aspect of the present disclosure, an interlock system includes a rotating cam and an interlock switch. An engagement element of a door hook is configured to rotate a rotating cam to engage the interlock switch as a door assembly moves to a closed position. An engagement element of a door hook is configured to rotate the rotating cam to disengage from the interlock switch as the door assembly is moved to an opened position.

According to an aspect of the present disclosure, a relationship between a door hook and an interlock switch as a door assembly is moved from a closed position to an opened position determines a point where the interlock switch is adjusted to stop power to a magnetron.

According to an aspect of the present disclosure, a door hook includes a coupling portion disposed on a base, an engagement portion disposed between the base and an inner panel, and an engagement element extending from the engagement portion. A adjustment assembly is operably coupled to the coupling portion.

According to an aspect of the present disclosure, an engagement portion is moved between abutting an inner panel and abutting a base to define a range of movement for a door hook.

According to an aspect of the present disclosure, an adjustment assembly includes at least one of an eccentric screw, a rack and pinion gear set, and a biasing member and an insert.

According to an aspect of the present disclosure, a door hook assembly for a cooking appliance includes a base defining an opening and a door hook disposed within the opening. The door hook has an engagement portion and a coupling portion. The door hook defines a receiving aperture. The engagement portion includes an engagement element configured to engage an interlock system of a cooking appliance. The door hook assembly also includes an adjustment assembly operably coupled to the door hook and that is configured to drive a linear translation of the door hook and a door hook fastener selectively disposed within the receiving aperture. The door hook fastener is movable between an unfixed condition and a fixed condition. The door hook is linearly translatable relative to the base when the door hook fastener is in the unfixed condition. The door hook is fixed to the base when the door hook fastener is in the fixed condition.

According to an aspect of the present disclosure, a door hook defines a second receiving aperture. An adjustment assembly includes an eccentric screw disposed in the second receiving aperture. A rotational movement of the eccentric screw drives the linear translation of the door hook.

According to an aspect of the present disclosure, an eccentric screw includes a proximal portion having a screw head, a distal portion coaxial with the proximal portion along a rotational axis, and a middle portion between and offset from the proximal portion and the distal portion.

According to an aspect of the present disclosure, an adjustment assembly includes a rack and pinion gear set. The rack and pinion gear set includes a rack coupled to a door hook and a pinion operably coupled to the rack. A rotational movement of the pinion about a rotational axis drives a linear translation of the door hook via engagement with the rack.

According to an aspect of the present disclosure, an adjustment assembly includes a biasing member disposed within a base between a door hook and a first support section of the base and an insert disposed between a coupling portion of the door hook and a second support section of the base. The biasing member provides a biasing force that biases the door hook towards the second support section. The insert provides an opposing force that drives the door hook toward the first support section of the base.

According to an aspect of the present disclosure, an engagement portion includes outwardly extending abutting elements. The outwardly extending abutting elements are perpendicular relative to an engagement element and are configured to limit a linear translation of a door hook.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking appliance, comprising:
an outer housing defining a receiving opening;
an interlock system disposed within the outer housing proximate to the receiving opening, wherein the interlock system includes a rotating cam and an interlock switch; and
a door assembly operably coupled to the outer housing, wherein the door assembly includes:
an inner panel defining an access aperture;
a base operably coupled to the inner panel, wherein the base defines an upper opening;
a door hook disposed in the upper opening of the base; and
an adjustment assembly operably coupled to the door hook, wherein the adjustment assembly is configured to linearly translate the door hook relative to the inner panel to adjust a position of the door hook, and wherein the position of the door hook adjusts an engagement between the door hook and the interlock system.

2. The cooking appliance of claim 1, wherein the door hook is configured to rotate the rotating cam to engage the interlock switch when the door assembly is in a closed position, and wherein the door hook is configured to rotate the rotating cam to disengage from the interlock switch as the door assembly is moved to an opened position.

3. The cooking appliance of claim 2, further comprising:
a magnetron configured to generate microwaves, wherein a point of disengagement between the interlock switch and the rotating cam defines a breaking point for stopping power to the magnetron, and wherein the position of the door hook determines the breaking point.

4. The cooking appliance of claim 1, wherein the adjustment assembly includes an eccentric screw having an offset portion, and wherein the eccentric screw extends through the door hook, and further wherein rotation of the eccentric screw is configured to drive linear translation of the door hook.

5. The cooking appliance of claim 1, wherein the adjustment assembly includes a rack coupled to the door hook and a pinion operably coupled to the door assembly, and wherein rotation of the pinion drives movement of the rack and, consequently, linear translation of the door hook.

6. The cooking appliance of claim 1, wherein the adjustment assembly includes a biasing member extending between the door hook and a first support section of the base, and wherein the adjustment assembly further includes an insert configured to be positioned between a second support section of the base and the door hook to drive linear translation of the door hook against a biasing force.

7. The cooking appliance of claim 1, wherein the door assembly includes a fixing fastener configured to extend through the door hook and fix the position of the door hook relative to the base and, consequently, set a relationship between the door hook and the interlock system.

8. The cooking appliance of claim 1, wherein the position of the door hook determines a distance of movement of the door assembly from a closed position to an opened position that causes disengagement between the interlock switch and the rotating cam to affect operation of said cooking appliance.

9. A cooking appliance, comprising:
a housing;
an interlock system disposed within the housing;
a door assembly including an inner panel defining an access aperture; and
a door hook assembly operably coupled to the door assembly, wherein the door hook assembly includes:
a base defining an upper opening;
a door hook positioned within the upper opening, wherein the door hook includes an engagement element configured to extend into the housing to engage the interlock system when the door assembly is in a closed position; and
an adjustment assembly operably coupled to the door hook, wherein the adjustment assembly is configured to drive linear translation of the door hook to adjust a position of the door hook relative to the base, and wherein the position of the door hook adjusts a relationship between the door hook and an interlock switch as the door assembly is moved from the closed position to an opened position.

10. The cooking appliance of claim 9, wherein the interlock system includes a rotating cam and the interlock switch, and wherein the engagement element of the door hook is configured to rotate the rotating cam to engage the interlock switch as the door assembly moves to the closed position, and wherein the engagement element of the door hook is configured to rotate the rotating cam to disengage from the interlock switch as the door assembly is moved to the opened position.

11. The cooking appliance of claim 10, further comprising:
a magnetron, wherein the relationship between the door hook and the interlock switch as the door assembly is moved from the closed position to the opened position determines a point where the interlock switch is adjusted to stop power to the magnetron.

12. The cooking appliance of claim 9, wherein the door hook includes a coupling portion disposed on the base, an engagement portion disposed between the base and the inner panel, and the engagement element extending from the engagement portion, and wherein the adjustment assembly is operably coupled to the coupling portion.

13. The cooking appliance of claim 12, wherein the engagement portion is moved between abutting the inner panel and abutting the base to define a range of movement for the door hook.

14. The cooking appliance of claim 9, wherein the adjustment assembly includes at least one of an eccentric screw, a rack and pinion gear set, and a biasing member and an insert.

15. A door hook assembly for a cooking appliance, comprising:
a base defining an opening;
a door hook disposed within the opening, the door hook having an engagement portion and a coupling portion, the door hook defining a receiving aperture, wherein the engagement portion includes an engagement element configured to engage an interlock system of said cooking appliance;
an adjustment assembly operably coupled to the door hook, the adjustment assembly being configured to drive a linear translation of the door hook; and
a door hook fastener selectively disposed within the receiving aperture, the door hook fastener being movable between an unfixed condition and a fixed condition, wherein the door hook is linearly translatable relative to the base when the door hook fastener is in the unfixed condition, and wherein the door hook is fixed to the base when the door hook fastener is in the fixed condition.

16. The door hook assembly of claim 15, wherein the door hook defines a second receiving aperture, and wherein the adjustment assembly includes an eccentric screw disposed in the second receiving aperture, and wherein a rotational movement of the eccentric screw drives the linear translation of the door hook.

17. The door hook assembly of claim 16, wherein the eccentric screw includes a proximal portion having a screw head, a distal portion coaxial with the proximal portion along a rotational axis, and a middle portion between and offset from the proximal portion and the distal portion.

18. The door hook assembly of claim 15, wherein the adjustment assembly includes a rack and pinion gear set, the rack and pinion gear set including a rack coupled to the door hook and a pinion operably coupled to the rack, and wherein a rotational movement of the pinion about a rotational axis drives the linear translation of the door hook via engagement with the rack.

19. The door hook assembly of claim 15, wherein the adjustment assembly includes a biasing member disposed within the base between the door hook and a first support section of the base and an insert disposed between the coupling portion of the door hook and a second support section of the base, and wherein the biasing member provides a biasing force that biases the door hook towards the second support section, and wherein the insert provides an opposing force that drives the door hook toward the first support section of the base.

20. The door hook assembly of claim 15, wherein the engagement portion includes outwardly extending abutting elements, wherein the outwardly extending abutting elements are perpendicular relative to the engagement element and are configured to limit the linear translation of the door hook.
